(19) United States
(12) Patent Application Publication
(10) Pub. No.: US 2006/0050060 A1
(43) Pub. Date: Mar. 9, 2006

(54) Apparatus and method for integrating touch input and portable media player module of notebook computers

(76) Inventor: Chih-Ching Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/128,201

(22) Filed: May 13, 2005

(30) Foreign Application Priority Data
Sep. 9, 2004 (TW) 93127263

(51) Int. Cl. G09G 5/00

(52) U.S. Cl. 345/173

(57) ABSTRACT

A module integrating a touch input and a portable multimedia player is provided, including a micro controller, a data transmission interface, a touch display module, an audiovisual data storage, an audio player, and a power supply. The data transmission interface is connected to the micro controller so that the micro controller can download the selected audiovisual data through data transmission interface from the notebook computer when the module is engaged in the slot of the notebook computer. The touch display module includes a touch panel and a display unit. The audiovisual data storage is for storing the audiovisual data of certain format downloaded from the notebook computer. The audio player is connected to the micro controller, and can play the audio under the control of the micro controller. When the integrated module is disengaged from the slot of the notebook computer, the power supply provides the operating power to the integrated module.

### FIELD OF THE INVENTION

The present invention relates to an apparatus for integrating touch input and portable media player of notebook computers and related control method, and more particularly, to an apparatus that can be used as a touch input device for a notebook computer and as a stand-alone portable media player and related control method.

### BACKGROUND OF THE INVENTION

As the computer and digital technology progresses, computers are widely used in offices, household entertainment, and various business occasions. The portable multimedia technology further integrates the multimedia playing and related devices into the notebook computers so that the user can view or listen to the audiovisual data played by notebook computers.

However, as the market demands thinner and smaller devices, using the notebook computer for multimedia playing is still considered as inconvenient. The portable multimedia player is developed to meet he market demands. By using the portable multimedia player for multimedia playing and with a micro storage device for storing multimedia data, the user can play the multimedia data without connecting to a notebook computer or an operating system.

Although the current portable multimedia player with a micro storage can store and play a large amount of multimedia data, such as MP3 or MPEG, it still requires a computer for downloading the multimedia data and synchronizing the data to the portable multimedia player. That is, the data is transmitted twice. This is not only time-consuming but also costly because the requirement of a computer. For those users who are less experienced with computers, it is still inconvenient to correctly connect the portable multimedia player to the computer and perform the aforementioned downloading and synchronizing tasks.

In addition, the portable multimedia player only functions as a player for audiovisual data. When connected to a computer, the portable multimedia player can neither serve as an auxiliary module nor multi-functional module. The user still needs to purchase various functional modules and carry these modules individually with the computer when requiring different functions.

Therefore, it is imperative to design a multi-functional portable multimedia playing module that is easy for downloading multimedia data and easy to operate to meet the market needs.

### SUMMARY OF THE INVENTION

The present invention is provided to overcome the aforementioned drawbacks of the conventional technologies. The primary objective of the present invention is to provide an integrated module that can serve as a touch input device for a notebook computer and as a portable multimedia player. When the integrated module is engaged in the slot of a notebook computer, the micro controller operates in a cursor mode, and when the integrated module is disengaged from the notebook computer, the micro controller operates in a multimedia playing mode.

Another objective of the present invention is to provide an integrated multimedia playing module that is easy for downloading multimedia audiovisual data. When the integrated module is engaged in the slot of a notebook computer, the user can easily operate the module to download the audiovisual data to the module for future playing.

Yet another objective of the present invention is to provide a portable multimedia playing module that is easy to operate. When the module is disengaged from a notebook computer, the user can easily operate the module to play the audiovisual data.

To achieve the aforementioned objectives, the present invention provides a module integrating a touch input and a portable multimedia player, including a micro controller, a data transmission interface, a touch display module, audiovisual data storage, an audio player, and a power supply. The data transmission interface is connected to the micro controller so that the micro controller can download the selected audiovisual data through data transmission interface from the notebook computer when the module is engaged in the slot of the notebook computer. The touch display module includes a touch panel and a display unit. The audiovisual data storage is for storing the audiovisual data of certain format downloaded from the notebook computer. The audio player is connected to the micro controller, and can play the audio under the control of the micro controller. When the integrated module is disengaged from the slot of the notebook computer, the power supply provides the operating power to the integrated module.

When the integrated module is engaged in one of the default slot of the notebook computer, the micro controller operates in the cursor mode. By operating the touch display module, the user can control the cursor on the screen of the notebook computer, select the desired function, and download audiovisual data from the notebook computer. When the integrated module is disengaged from the slot of the notebook computer, the micro controller operates in the audiovisual playing mode. The audio player can play the audio data and the display unit of the touch display module can display the visual data.

In a preferred embodiment of the present invention, the module further includes a re-charge circuit and the power supply further includes a re-chargeable battery. The re-charge circuit can draw power from the notebook computer through the data transmission interface when the module is engaged in the slot of the notebook computer.

In comparison with the conventional techniques, the present invention provides a single module that can be used as both a touch input device to a notebook computer and a portable multimedia player when disengaged from the notebook computer. When purchasing a notebook computer including the present invention, the user does not require to purchase a separate portable multimedia player. Furthermore, when the integrated module of the present invention is engaged in the notebook computer, the user can easily operate the module to download the audiovisual data from the notebook to the module for future playing.

These and other objectives, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a perspective view of a module integrating a touch input device and a portable multimedia player of the present invention engaged in a notebook;

FIG. 2 shows a perspective view of a module integrating a touch input device and a portable multimedia player of the present invention disengaged from a notebook;

FIG. 3 shows a schematic view of the integrated module of the present invention;

FIG. 4 shows a block diagram of a first embodiment of the circuits of the structure of the present invention;

FIG. 5 shows a flowchart of a first embodiment of the control method of the present invention;

FIG. 6 shows a block diagram of a second embodiment of the circuits of the structure of the present invention; and

FIG. 7 shows a flowchart of a second embodiment of the control method of the present invention.

### DETAILED DESCRIPTION OF THE PREFERRED EMBODIMENT OF THE PRESENT INVENTION

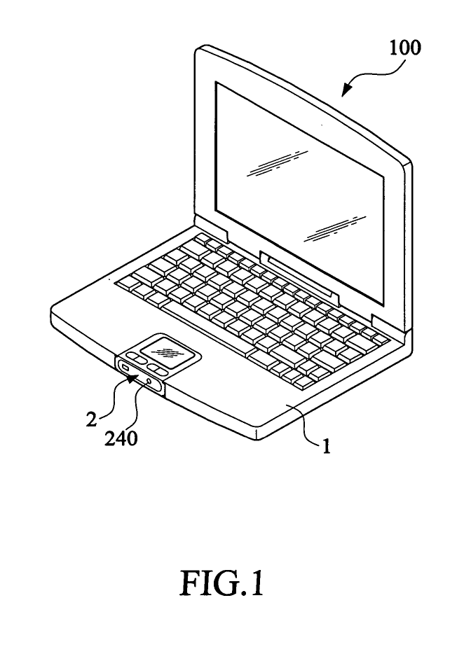

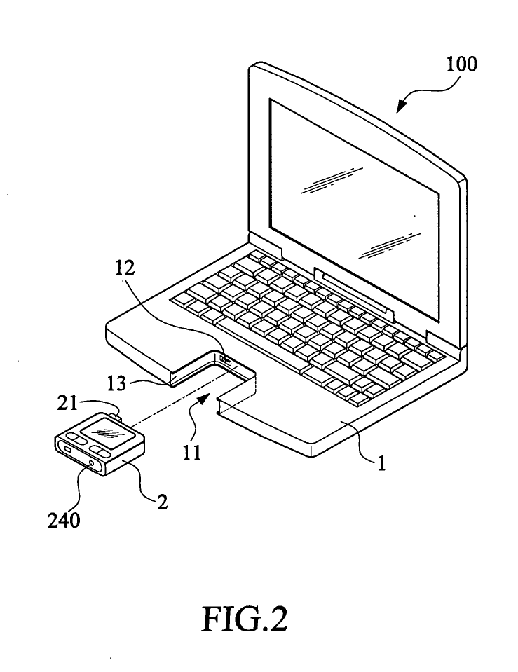

With reference to the drawings and in particular to FIGS. 1 and 2, which show the condition when an integrated module constructed in accordance with the present invention engaged in a notebook computer, and disengaged from the notebook computer, a notebook computer 100 includes a slot 11 defined in a case 1. The slot 11 further includes a connector 12, which can be a conventional serial connector, parallel connector or USB connector.

An integrated module constructed in accordance with the present invention, generally designated with reference numeral 2, can be plugged into the slot 11 of the case 1 of the notebook computer 100 so that a connector 21 of the module 2 can be engaged with the connector 12 of the slot 11 and electrically connected to the notebook computer 100. The module 2 of the present invention can be disengaged from the notebook computer 100.

The side wall of the slot 11 can further-include a guiding trench 13 so that the module 2 can be smoothly plugged into the slot 11 and connector 21 of the module 2 can be steadily engaged with the connector 12 of the slot 11.

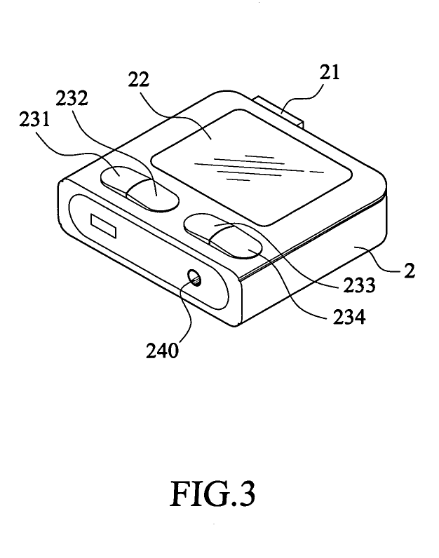

Also referring to FIG. 3, which shows a schematic view of the module 2 of the present invention, the module 2 includes a touch display module 22. A plurality of function buttons 231, 232, 233, 234 is placed near the touch display module 22. An earphone plug is placed at the front end of the touch display module 22.

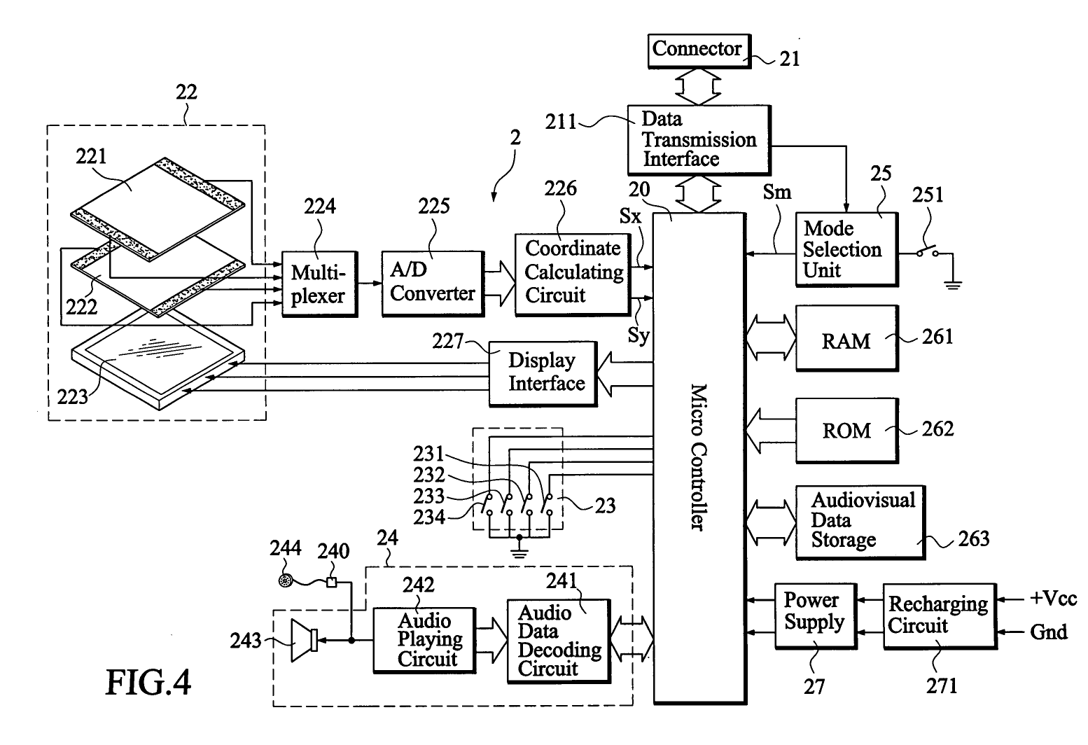

Also referring to FIG. 4, which shows a functional block diagram of a first embodiment of the present invention, the module 2 includes a micro controller 20, which is connected to the connector 21 through a data transmission interface 211. The connector 21 can be connected to the connector 12 of the slot 11 of the notebook computer 100, as shown in FIG. 2. Therefore, the micro controller 20 can transmit or receive control signals from the notebook computer 100 as well as upload and download data. The data transmission interface 211 is preferably a plug-and-play and hot plug interface.

The touch display module 22 of the integrated module 2 includes an upper touch layer 221, a lower touch layer 222, and a display unit 223. The touch display the module 22 can use the conventional thin-film resistive touch screen and LCD technologies. The structure mainly includes a spacer dot matrix between the touch layers, and the combined layers are embedded into a conductive substrate (not shown). The upper touch layer 221 and the lower touch layer 222 form a touch panel. When the touch display module 22 is touched, the location (X, Y) of the touch will be detected by the spacer dot matrix, and the signal will be sent by the signal output line.

The signal output lines of the upper touch layer 221 and the lower touch layer 222 are connected to the inputs of a multiplexer 224 respectively. The multiplexer 224 is used as a selector of the (X, Y) coordinates from a plurality of (X, Y) coordinate sets generated by the upper touch layer 221 and the lower touch layer 222. The selected set of (X, Y) coordinates is then output from the output end. The touch signal after the multiplexer 224 is digitized by an analog-to-digital (A/D) converter 225, and a coordinate calculating circuit 226 will calculate the (X, Y) coordinates and send the X-axis coordinate signal Sx and Y-axis coordinate signal Sy to the micro controller 20.

The display unit 223 of the touch display the module 22 provides the functions of displaying text and images. The display unit 223 is connected to the micro controller 20 through a display interface 227 so that the text and the images transmitted from the micro controller 20 can be displayed.

The micro controller 20 is connected to a set of control buttons 23, including buttons 231, 232, 233, 234 with pre-set functions for user's operation. When the integrated the module 2 of the present invention operates in a cursor control mode, the buttons 231, 232, 233, 234 of the control button set 23 can be used as function buttons of general touch panel, such as select, confirm, and so on. When the integrated module 2 of the present invention operates in an audiovisual playing mode, the buttons 231, 232, 233, 234 of the control button set 23 can be used as function buttons of media player, such as select, play, stop, and so on.

The integrated module 2 of the present invention also includes an audio player 24, connected to the micro controller 20, for playing audio data. The audio player 24 includes an audio data decoding circuit 241, an audio playing circuit 242, and an audio generation unit 243. The audio data decoding circuit 241 can decode digital audio data and the audio playing circuit 242 plays the decided audio through the audio generation unit 243. The output end of the audio playing circuit 242 can also be connected to an earphone outlet 240 so that the user can use an earphone 244 for listening.

A mode selection unit 25 is connected to the micro controller 20 for detecting the operating mode of the integrated module 2 of the present invention, such as being engaged or disengaged from the slot 11 of the notebook computer 100, and for sending a mode switch signal Sm to the micro controller 20 so that the micro controller 20 can determine whether to operate in cursor control mode or audiovisual playing mode. The mode selection unit 25 can automatically detects the operation mode. For example, the mode selection unit 25 can detect whether the integrated module 2 is engaged in the slot 11 of the notebook computer 100 through data transmission interface.

On the other hand, the mode selection unit 25 also provides detection of manual change of operation mode of the micro controller 20 through a mode switch 251. The mode switch 251 can be placed at the front side of the integrated module 2. When the module 2 is inserted into the slot 11 of the case 1 of the notebook computer 100, the mode switch 251 is triggered and the mode selection unit 25 sends a mode switching signal Sm to the micro controller 20.

The integrated module 2 of the present invention also includes a RAM 261, a ROM 262, and audiovisual data storage 263. The user can store digital audiovisual data of MP3 or other formats in the data storage 263. The audiovisual data storage 263 can be implemented using flash drive, data memory card, or micro hard disk.

The integrated module 2 also includes a power supply 27, which is preferably a re-chargeable battery. When the module 2 is engaged in the slot 11 of the case 1 of the notebook computer 100, the re-chargeable battery can draw power source Vcc from the connector 12 of the slot 11 of the notebook computer 100 through the data transmission interface 211 and the connector 21, and recharged by a recharging circuit 271. When the module 2 is disengaged from the slot 11 of the case 1 of the notebook computer 100, the power supply 27 provides the needed operating voltage to all the circuit units.

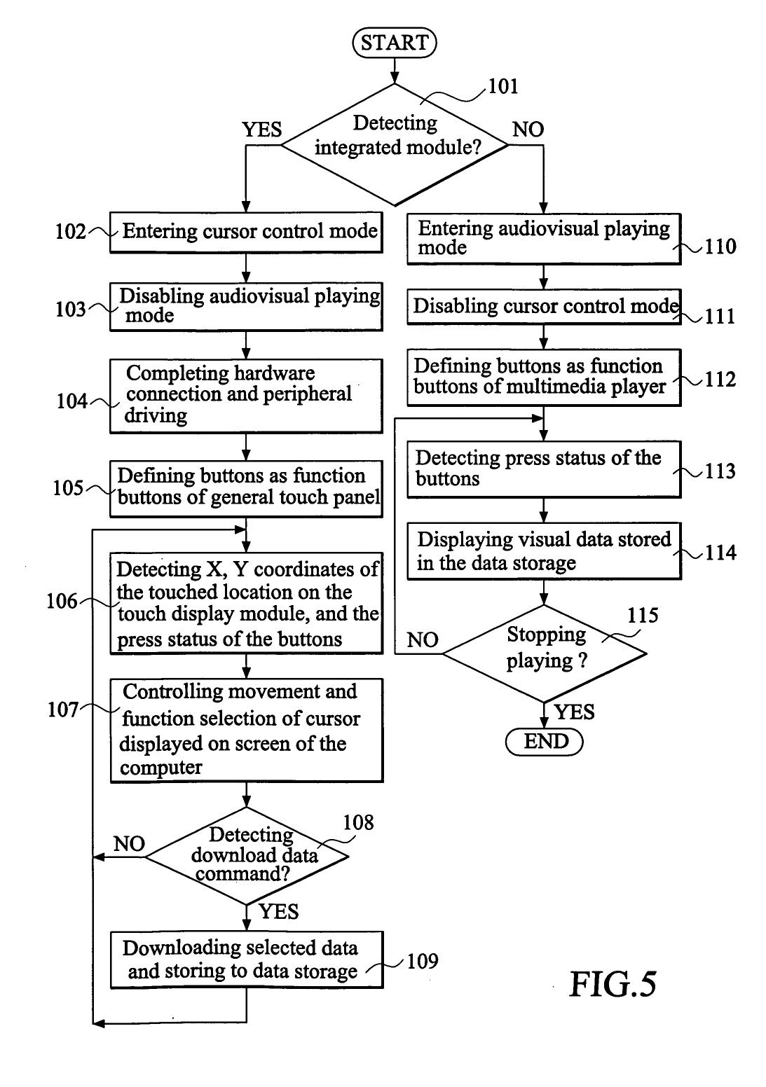

Also referring FIG. 5, which shows a flowchart of control method for the first embodiment of the present invention, the following description of the control flow also refers to the control circuits in FIG. 4. Step 101 is for the mode selection unit 25 of the module 2 to detect whether the module 2 is engaged or disengaged from the slot 11 of the notebook computer 100.

When the module 2 is detected as engaged in the slot 11 of the notebook computer 100, the micro controller 20 enters the cursor control mode (step 102). In this operation mode, the module 2 of the present invention disables the audiovisual playing mode (step 103) and completes the hardware connection and peripheral driving (step 104) with the notebook computer 100 so that the micro controller 20 of the module 2 operates in a cursor control mode.

Next, the micro controller 20 of the module 2 configures the functions of the buttons 231, 232, 233, 234 of the control button set 23. When the user presses any button, the button can be used as a function button of a general touch panel (step 105).

Then, the micro controller 20 of the module 2 detects the (X, Y) coordinates of the touched location on the touch display module 22, and the press status of the buttons 231, 232, 233, 234 (step 106). All the signals are sent to the notebook computer 100 through the data transmission interface 211 and the connector 21. Step 107 is to control the movement and the function selection of the cursor displayed on the screen of the notebook computer 100.

The downloading of data can be performed in the cursor control mode. When the user wants to download data, a download command is issued (step 108) by either pressing a control button or clicking a program with the cursor. The selected data will be downloaded from the notebook computer 100 through the data transmission interface 211 to the data storage 263 (step 109).

The user can program, for example, through the function buttons, the audiovisual data stored in the data storage 263, including setting preference or editing playing sequence, and so on.

When the module 2 of the present invention is disengaged from the notebook computer 100, the micro controller 20 enters the audiovisual playing mode (step 110). In this operation mode, the module 2 of the present invention disables the cursor control mode (step 111). Next, the micro controller 20 of the module 2 configures the functions of the buttons 231, 232, 233, 234 of the control button set 23. When the user presses any button, the button can be used as a function button of a multimedia player (step 112).

Then, the micro controller 20 of the module 2 can detect the press status of the buttons 231, 232, 233, 234 (step 113). When the user presses the configured multimedia playing buttons, the micro controller 20 displays the visual data stored in the data storage 263 on the display unit 223 of the touch display module 22 through the display interface 227 and plays the audio data stored through the audio playing circuit 222 (step 114). The audio can be played through the audio generation unit 243 or through the earphone 244 plugged in the earphone outlet 240. When the user selects the stop playing button (step 115), the playing of audiovisual data stops.

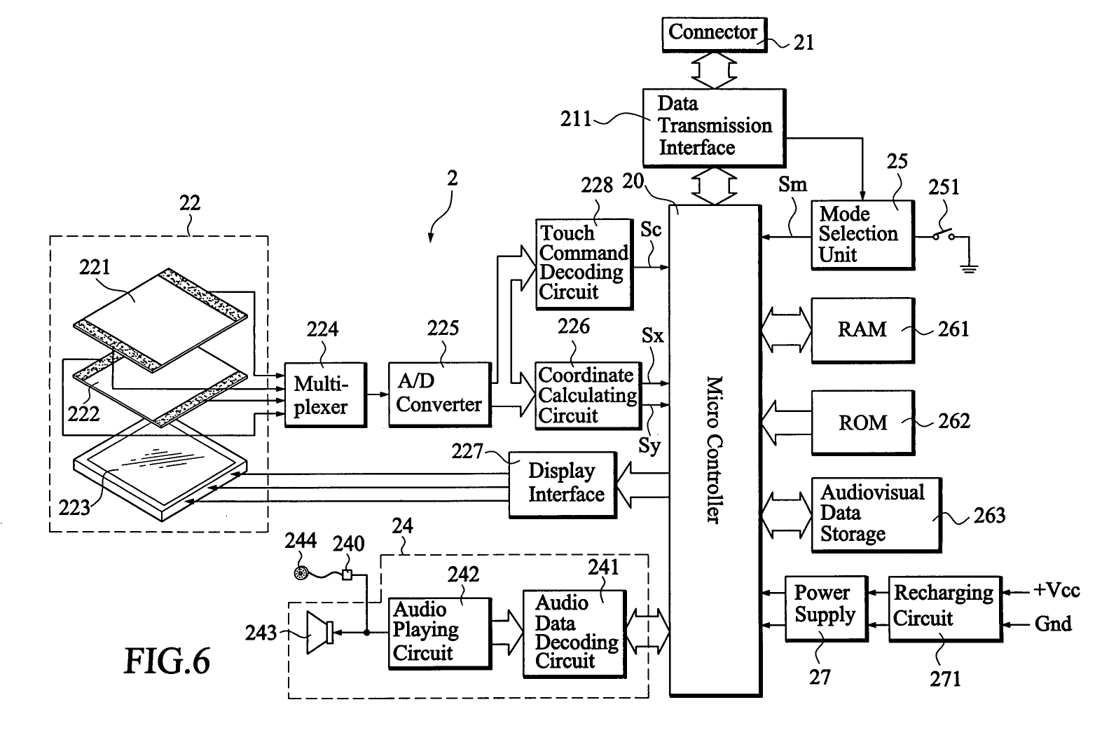

Also referring to FIG. 6, which shows a second embodiment of the present invention, in the second embodiment, most of the circuits of the module 2 are similar to those of the module 2 in the first embodiment, except that the second embodiment does not include a plurality of buttons 231, 232, 233, 234. Instead, the second embodiment uses the upper touch layer 221, the lower touch layer 222, the display unit 223 of the touch display module 22 to perform the functions of (X, Y) coordinate detection, text and image display and function selection.

In other words, when the module 2 is in the cursor control mode, icons representing the buttons 231, 232, 233, 234 can be displayed on the touch display module 22 for selection or pressing as the function buttons of a touch panel. When the module 2 is in the audiovisual playing mode, the icons representing buttons 231, 232, 233, 234 can be displayed on the touch display module 22 for selection or pressing as the function buttons of a multimedia player.

In this embodiment, the micro controller 20 is connected to a touch command decoding circuit 228 for receiving the location signal of the touch display module 22 and decoding the corresponding command of that location. The decoded command Sc is then sent to the micro controller 20. When the module 2 operates in cursor control mode, the command Sc corresponding to the decoded location signal will be transmitted to the notebook computer 100 through the data transmission interface 211. When the module 2 operates in audiovisual playing mode, the command Sc corresponding to the decoded location signal will be used as the control to the audiovisual playing.

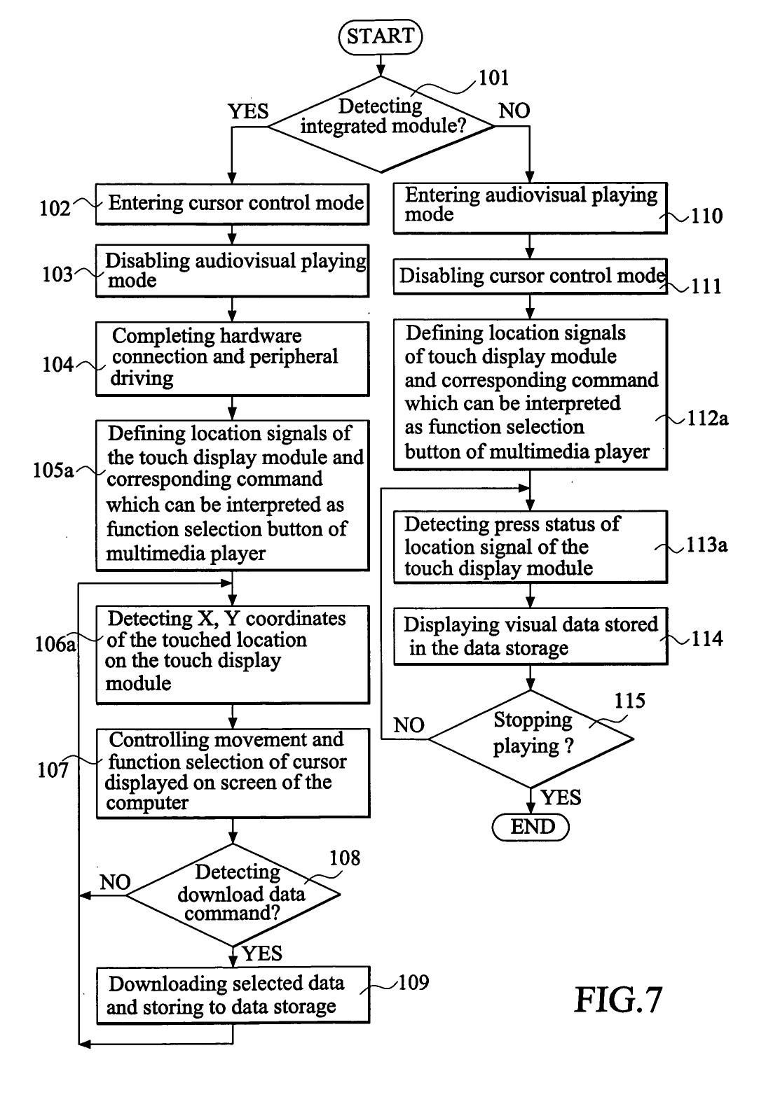

Also referring to FIG. 7, which shows a flowchart of control method for the second embodiment of the present invention, most of the steps are similar to those shown in FIG. 5, and hence have the same step number. Step 101 is for the mode selection unit 25 of the module 2 to detect whether the module 2 is engaged or disengaged from the slot 11 of the notebook computer 100.

When the module 2 is detected as engaged in the slot 11 of the notebook computer 100, the micro controller 20 enters the cursor control mode (step 102). In this operation mode, the module 2 of the present invention disables the audiovisual playing mode (step 103) and completes the hardware connection and peripheral driving (step 104) with the notebook computer 100 so that the micro controller 20 of the module 2 operates in a cursor control mode.

Next, the micro controller 20 of the module 2 configures the location signals of the touch display module 22 and corresponding command so that when the user touches or presses the touch display module 22, it can be interpreted as a function selection button of a touch panel (step 105a).

Then, the micro controller 20 of the module 2 detects the (X, Y) coordinates of the touched location on the touch display module 22 (step 106a), and the signals are sent to the notebook computer 100 through the data transmission interface 211 and the connector 21. Step 107 is to control the movement and the function selection of the cursor displayed on the screen of the notebook computer 100.

The downloading of data can be performed in the cursor control mode. When the user wants to download data, a download command is issued (step 108) by either pressing a control button icon or clicking a program with the cursor. The selected data will be downloaded from the notebook computer 100 through the data transmission interface 211 to the data storage 263 (step 109).

The user can program, for example, through the function buttons icons, the audiovisual data stored in the data storage 263, including setting preference or editing playing sequence, and so on.

When the module 2 of the present invention is disengaged from the notebook computer 100, the micro controller 20 enters the audiovisual playing mode (step 110). In this operation mode, the module 2 of the present invention disables the cursor control mode (step 111). Next, the micro controller 20 of the module 2 configures the location signals of the touch display module 22 and corresponding command so that when the user touches or presses the touch display module 22, it can be interpreted as a function selection button of a multimedia player (step 112a).

Then, the micro controller 20 of the module 2 can detect the press status of location signal of the touch display module 22 (step 113a). When the user presses the configured multimedia playing buttons, the micro controller 20 displays the visual data stored in the data storage 263 on the display unit 223 of the touch display module 22 through the display interface 227 and plays the audio data stored through the audio playing circuit 222 (step 114). The audio can be played through the audio generation unit 243 or through the earphone 244 plugged in the earphone outlet 240. When the user selects the stop playing button (step 115), the playing of audiovisual data stops.

From the aforementioned description, the integrated module of the present invention and related control method can provide practical improvement to the conventional technologies and products. While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. An integrated module integrating a touch input of a computer and a portable multimedia player for engaging in a slot of a notebook computer or disengaged from said slot of said notebook computer, said module comprising:
a micro controller, for operating in a cursor control mode or an audiovisual playing mode;
a data transmission interface, connected to said micro controller, for said micro controller to download audiovisual data from said notebook computer through said data transmission interface when said integrated module engaged in said slot of said notebook computer;
a touch display module, located on said integrated module and connected to said micro controller, said touch display module further comprising a touch panel and a display unit;
a set of buttons, comprising at least a control button, when said micro controller operating in said cursor control mode, said control button being defined as function button of a touch panel, when said micro controller operating in said audiovisual playing mode, said control button being defined as function button of a multimedia player;
an audiovisual data storage, for storing audiovisual data downloaded from said notebook computer;
an audio player, connected to said micro controller, for playing audio under the control of said micro controller; and
a power supply, for providing operating power to said integrated module when said integrated module disengaged from said notebook computer;
where said micro controller operating in said cursor control mode when said integrated module being engaged to said slot of said notebook computer, said touch panel of said touch display module controlling the cursor movement or function selection on the screen of said notebook computer through said data transmission interface; and said micro controller operating in said audiovisual playing mode when said integrated module being disengaged from said slot of said notebook computer, under the control of said control button set and said micro controller, said audio player playing audio data stored in said audiovisual data storage, and said display unit of said touch display module displaying visual data.

2. The integrated module as claimed in claim 1, wherein said data transmission interface further comprises a first connector formed in said integrated module, and a second connector formed in said slot of said notebook computer.

3. The integrated module as claimed in claim 1, wherein said touch panel of said touch display module uses a multiplexer, an A/D converter, a coordination calculating circuit to transmit the (X, Y) location signal of a touched spot of said touch panel to said micro controller.

4. The integrated module as claimed in claim 1, wherein the data stored in said audiovisual data storage is of digital format.

5. The integrated module as claimed in claim 1, wherein said audio player further comprises an audio data decoding circuit for decoding said audiovisual data stored in said audiovisual data storage into audio signal, and an audio playing circuit for playing said decoded audio signal through an audio generation unit.

6. The integrated module as claimed in claim 5, wherein said audio player further comprises an earphone outlet, located at a specific location of said integrated module.

7. The integrated module as claimed in claim 1 further comprising a re-charging circuit and said power supply comprises at least a re-chargeable battery for recharging through said re-charging circuit.

8. The integrated module as claimed in claim 1 further comprising a mode selection unit, connected to said micro controller, for detecting whether said integrated module being engaged to or disengaged from said slot of said notebook computer, and generating a mode switch signal to said micro controller so that said micro controller being able to decide whether to operate in said cursor control mode or in said audiovisual playing mode.

9. An integrated module integrating a touch input of a computer and a portable multimedia player for engaging in a slot of a notebook computer or disengaged from said slot of said notebook computer, said module comprising:
a micro controller, for operating in a cursor control mode or an audiovisual playing mode;
a data transmission interface, connected to said micro controller, for said micro controller to download audiovisual data from said notebook computer through said data transmission interface when said integrated module engaged in said slot of said notebook computer;
a touch display module, located on said integrated module and connected to said micro controller, said touch display module further comprising a touch panel and a display unit;
a touch command decoding circuit, connected to said micro controller for receiving location signal of said touch display module and for decoding said location signal into a corresponding command, and then sending said command to said micro controller;
an audiovisual data storage, for storing audiovisual data downloaded from said notebook computer;
an audio player, connected to said micro controller, for playing audio under the control of said micro controller; and
a power supply, for providing operating power to said integrated module when said integrated module disengaged from said notebook computer;
where said micro controller operating in said cursor control mode when said integrated module being engaged to said slot of said notebook computer, said touch panel of said touch display module controlling the cursor movement or function selection on the screen of said notebook computer through said data transmission interface; and said micro controller operating in said audiovisual playing mode when said integrated module being disengaged from said slot of said notebook computer, under the control of said touch display module and said micro controller, said audio player playing audio data stored in said audiovisual data storage, and said display unit of said touch display module displaying visual data.

10. The integrated module as claimed in claim 9, wherein said data transmission interface further comprises a first connector formed in said integrated module, and a second connector formed in said slot of said notebook computer.

11. The integrated module as claimed in claim 9, wherein said touch panel of said touch display module uses a multiplexer, an A/D converter, a coordination calculating circuit to transmit the (X, Y) location signal of a touched spot of said touch panel to said micro controller.

12. The integrated module as claimed in claim 9, wherein the data stored in said audiovisual data storage is of digital format.

13. The integrated module as claimed in claim 9, wherein said audio player further comprises an audio data decoding circuit for decoding said audiovisual data stored in said audiovisual data storage into audio signal, and an audio playing circuit for playing said decoded audio signal through an audio generation unit.

14. The integrated module as claimed in claim 13, wherein said audio player further comprises an earphone outlet, located at a specific location of said integrated module.

15. The integrated module as claimed in claim 9 further comprising a re-charging circuit and said power supply comprises at least a re-chargeable battery for recharging through said re-charging circuit.

16. The integrated module as claimed in claim 9 further comprising a mode selection unit, connected to said micro controller, for detecting whether said integrated module being engaged to or disengaged from said slot of said notebook computer, and generating a mode switch signal to said micro controller so that said micro controller being able to decide whether to operate in said cursor control mode or in said audiovisual playing mode.

17. A method for controlling an integrated module integrating a touch input of a computer and a portable multimedia player for engaging in a slot of a notebook computer or disengaged from said slot of said notebook computer, said method comprising the steps of:
(a) detecting whether said integrated module being engaged to or disengaged from said slot of said notebook computer;
(b) said integrated module entering a cursor control mode when detecting said integrated module being engaged to said notebook computer, or said integrated module entering an audiovisual playing mode when detecting said integrated module being disengaged from said notebook computer;
(c) said integrated module completing hardware connection and driving with said notebook computer, and setting a touch display module as cursor movement control and function selection of a touch panel after said integrated module entering said cursor control mode, said touch display module controlling cursor movement and function selection of said notebook computer; and
(d) said integrated module being able to play an audiovisual data stored in said audiovisual data storage after said integrated module entering said audiovisual playing mode.

18. The method as claimed in claim 17 further comprising a step of:
(c1) when said integrated module operating in said cursor control mode, said integrated module downloading audiovisual data from said notebook computer through a data transmission interface and storing said downloaded data in a audiovisual data storage in said integrated module.

19. The method as claimed as claim 17, wherein in said step (c), said touch display module can send the coordinate location signal of a pressed spot on said touch display module to said integrated module.

20. The method as claimed in claim 19, wherein said touch display module further comprises a step of receiving location signal of said pressed spot on said touch display module, decoding said location signal into a corresponding touch command, and sending said command to said integrated module.
